(19) United States
(12) Patent Application Publication
(10) Pub. No.: US 2019/0056416 A1
(43) Pub. Date: Feb. 21, 2019

(54) SYSTEM IMPLEMENTING AIR QUALITY-BASED WASTE MANAGEMENT

(71) Applicant: Rubicon Global Holdings, LLC, Atlanta, GA (US)

(72) Inventor: Philip Rodoni, Decatur, GA (US)

(73) Assignee: Rubicon Global Holdings, LLC, Atlanta, GA (US)

(21) Appl. No.: 15/678,919

(22) Filed: Aug. 16, 2017

(51) Int. Cl. G01N 35/00; G06Q 10/00; G06F 3/0484

(52) U.S. Cl. CPC G01N 35/00613; G06F 3/0484; G06Q 10/30

(57) ABSTRACT

A waste management system is disclosed for use with a service vehicle. The waste management system may include a sensor configured to generate an air quality signal indicative of a quality of air in a vicinity of the service vehicle, a locating device configured to generate a location signal indicative of a location of the service vehicle, a display, and a controller in communication with the air quality sensor, the locating device, and the display. The controller may be configured to make a determination that the service vehicle is currently servicing a receptacle, and selectively use the air quality signal to determine a mix of waste in the receptacle based on the determination. The controller may also be configured to, based on the location signal, cause a representation of the mix of the waste to be shown together with the location of the service vehicle on the display.

### TECHNICAL FIELD

The present disclosure relates generally to a waste management system and, more particularly, to a system implementing management of solid waste based on air quality.

### BACKGROUND

In some applications of solid waste management, it can be important to know a mix of the solid waste collected by a service vehicle. For example, it can be important to know an amount (e.g., percent, weight, volume, etc.) of the collected waste that is recyclable, an amount of the collected waste that is compostable, and/or an amount of the collected waste that is hazardous. In some instances, this knowledge could be used to recommend ways to reduce, reuse, and/or sell portions of the waste in order for an associated customer to recoup some of the waste service cost. In other instances, the knowledge could be used to ensure compliance with governmental, municipal, or company regulations and safety standards.

Historically, a waste service representative (and/or the customer) would periodically observe the waste being dumped from a receptacle into a service vehicle and/or sift through waste inside the receptacle. The representative would then record information about the observed waste. For example, as a dumpster was lifted by a service vehicle and dumped into a bed of the vehicle, the representative would be on site to see the falling waste materials and record the materials as being cardboard, plastic, glass, biodegradable, compostable, and/or other. Alternatively, waste service representatives would be dispatched to physically evaluate the waste in one or more receptacles prior to service being performed to determine the mix and composition of waste materials in a receptacle. An analysis would then be performed based on the observations, and corresponding recommendations regarding how to best manage the solid waste would be made.

Although acceptable for some applications, these manual on-site audits may be less than optimal. In particular, these audits can be difficult, time-consuming, inaccurate, and potentially hazardous to the waste service representative. In addition, because of the difficulty and amount of time required for the audits, they may not be conducted frequently. As a result, the accuracy of the analysis and/or the benefit of the recommendation may be lower than desired for some applications.

The disclosed system is directed to overcoming one or more of the problems set forth above and/or other problems of the prior art.

### SUMMARY

In one aspect, the present disclosure is directed to a waste management system for use with a service vehicle. The waste management system may include a sensor configured to generate an air quality signal indicative of a quality of air in a vicinity of the service vehicle, a locating device configured to generate a location signal indicative of a location of the service vehicle, a display, and a controller in communication with the air quality sensor, the locating device, and the display. The controller may be configured to make a determination that the service vehicle is currently servicing a receptacle, and to selectively use the air quality signal to determine a mix of waste in the receptacle based on the determination. The controller may also be configured to, based on the location signal, cause a representation of the mix of the waste to be shown together with the location of the service vehicle on the display.

In another aspect, the present disclosure is directed to a method for managing waste retrieval by a service vehicle. The method may include sensing an air quality in a vicinity of the service vehicle, determining a location of the service vehicle, and making a determination that the service vehicle is currently servicing a receptacle. The method may also include selectively using the air quality to determine a mix of waste in the receptacle based on the determination and, based on the location of the service vehicle, displaying a representation of the mix of the waste together with the location of the service vehicle.

In yet another aspect, the present disclosure is directed to a non-transitory computer readable medium containing computer-executable programming instructions for a method of managing waste retrieval by a service vehicle. The method may include sensing an air quality in a vicinity of the service vehicle, determining a location of the service vehicle, and determining that the service vehicle is currently servicing a receptacle based on the location of the service vehicle. The method may also include using the air quality to determine a mix of waste in the receptacle only when the service vehicle is currently servicing the receptacle, and linking the air quality to the location of the service vehicle in an electronic map of the environment when the service vehicle is not currently servicing the receptacle. The method may further include selectively displaying at least one of the mix of the waste together with the location of the service vehicle or the electronic map.

### BRIEF DESCRIPTION OF THE DRAWINGS

FIG. 1 is an isometric illustration of an exemplary disclosed waste management environment;

FIG. 2 is a diagrammatic illustration of an exemplary disclosed system that may be used to manage the environment of FIG. 1; and

FIG. 3 is a flowchart depicting an exemplary disclosed method that may be performed by the system of FIG. 2.

### DETAILED DESCRIPTION

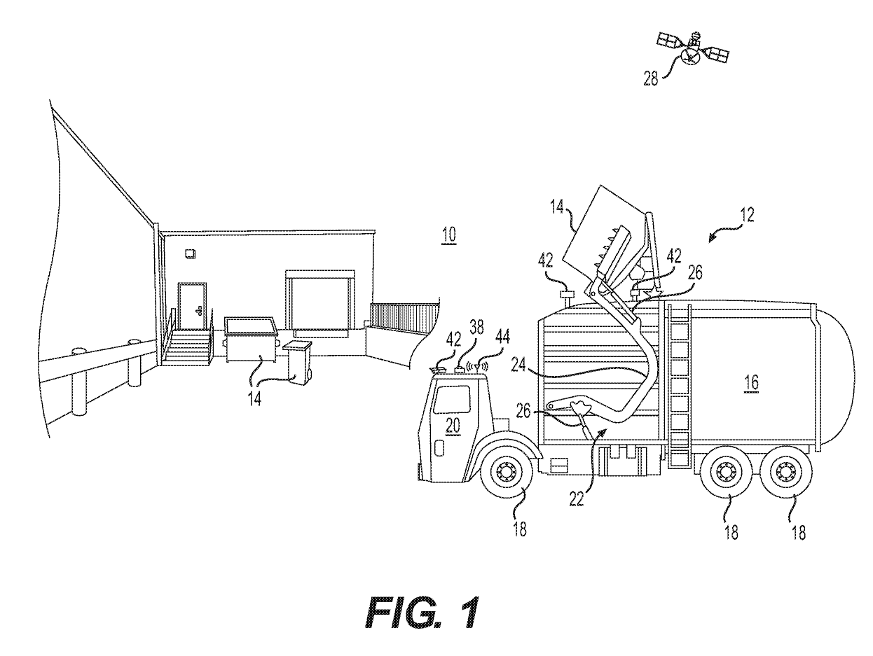

FIG. 1 illustrates an exemplary waste management environment (“environment”) 10, at which one or more service vehicles 12 are providing waste services. Environment 10 may include a retail store, a factory, a government building, a residential address, or another location having one or more receptacles 14 that require services of service vehicle 12. These services may include, for example, the retrieval of waste materials from inside of receptacle(s) 14, the replacement of receptacle(s) 14, and/or the placement of new or additional receptacles 14.

Service vehicle 12 may take many different forms. In the example shown in FIG. 1, service vehicle 12 is a hydraulically actuated, front-loading type of service vehicle. Specifically, service vehicle 12 may include a bed 16, a plurality of wheels 18, a cab 20 located forward of bed 16, and a lifting device 22 configured to pivot upward over a top of cab 20. Lifting device 22 may consist of, among other things, one or more lift arms 24 that engage and/or grasp receptacle 14, and one or more actuators 26 powered by pressurized oil to raise and/or tilt lift arms 24 (and receptacle 14) to a dump position over bed 16. After dumping of receptacle 14, pressurized oil may be released from hydraulic actuator(s) 26 to allow lowering of lift arms 24 and receptacle 14 back to the ground in front of service vehicle 12. In other examples, lifting device 22 may be located to pick up receptacles 14 from a side and/or a rear of service vehicle 12. In yet other examples, receptacles 14 may be manually lifted and dumped into bed 16.

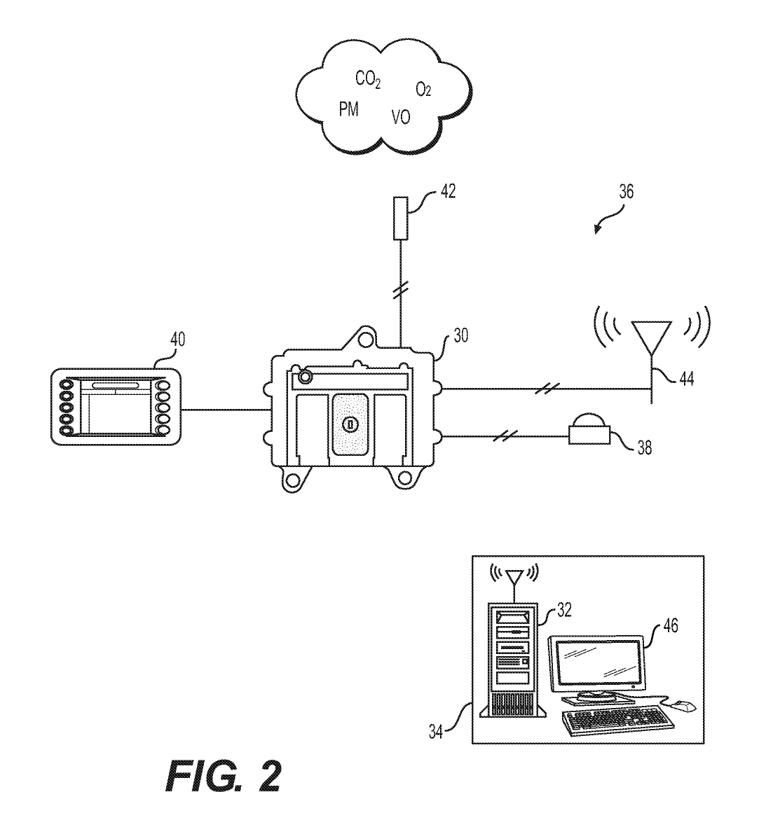

As service vehicle 12 moves about environment 10, a satellite 28 or other tracking device may communicate with an onboard controller 30 (shown only in FIG. 2) to monitor the movements of service vehicle 12 and the associated changes made to environment 10 (e.g., pickup, dumping, placement, etc.). As will be explained in more detail below, onboard controller 30, or a separate offboard controller 32 (e.g., a controller 32 located in a back office 34 or other service facility—shown only in FIG. 2), may then manage future operations of service vehicle 12 (and other similar service vehicles 12) based on these movements and changes.

Both of onboard and offboard controllers 30, 32 may include means for monitoring, recording, storing, indexing, processing, communicating, and/or controlling other onboard and/or offboard devices. These means may include, for example, a memory, one or more data storage devices, a central processing unit, or any other components that may be used to run the disclosed application. Furthermore, although aspects of the present disclosure may be described generally as being stored in memory, one skilled in the art will appreciate that these aspects can be stored on or read from different types of computer program products or computer-readable media such as computer chips and secondary storage devices, including hard disks, floppy disks, air quality media, CD-ROM, or other forms of RAM or ROM.

As shown in FIG. 2, onboard controller 30 may form a portion of a waste management system (“system”) 36 that is configured to track, assist, and/or control movements of service vehicle 12 (shown only in FIG. 1). In addition to onboard controller 30, system 36 may also include a locating device 38, a manual input device 40, and at least one air quality sensor 42. In some embodiments, controller 30, locating device 38, manual input device 40 and/or sensor 42 may be integrally formed and/or packaged together in a handheld unit carried by the operator of service vehicle 12. Onboard controller 30 may be in communication with each of these other components and/or with offboard controller 32 at back office 34 (e.g., via a communication device 44) and configured to determine, based on signals from these components and based on other known information stored in memory, the location of the service vehicle 12, characteristics and locations of receptacles 14 being moved by and/or in a vicinity of each service vehicle 12, a quality of air in a vicinity of service vehicle 12, and/or a mix of waste retrieved by service vehicle 12 during a service activity.

Locating device 38 may be configured to generate signals indicative of a geographical position and/or orientation of service vehicle 12 relative to a local reference point, a coordinate system associated with environment 10, a coordinate system associated with Earth, or any other type of 2-D or 3-D coordinate system. For example, locating device 38 may embody an electronic receiver configured to communicate with satellites 28 (referring to FIG. 1), or a local radio or laser transmitting system used to determine a relative geographical location of itself. Locating device 38 may receive and analyze high-frequency, low-power radio or laser signals from multiple locations to triangulate a relative 3-D geographical position and orientation. In some embodiments, locating device 38 may also be configured to determine a location and/or orientation of a particular part of service vehicle 12, for example of lift arms 24 (shown only in FIG. 1). Based on the signals generated by locating device 38 and based on known kinematics of service vehicle 12, onboard controller 30 may be able to determine in real time, the position, heading, travel speed, acceleration, and orientation of service vehicle 12 and lift arms 24. This information may then be used by onboard and/or offboard controllers 30, 32 to update the locations and conditions of service vehicle(s) 12 and/or receptacles 14 in an electronic map or database of environment 10.

It is contemplated that locating device 38 may take another form and/or incorporate additional elements, if desired. For example, locating device 38 could be an RFID reader configured to interact with an RFID tag located within environment 10 (e.g., at a customer location, on receptacle 14, etc.), or another type of scanner configured to read another type of indicia (e.g., a barcode) within environment 10. Based on the reading of the RFID tag or other indicia, the location and/or orientation of service vehicle 12 may be linked to the known location of the RFID tag or other indicia within environment 10.

Manual input device 40 may provide a way for an operator of service vehicle 12 to input information regarding observances made while traveling around environment 10. For example, the operator may be able to enter a type and/or condition of waste observed at a particular location, an amount of waste in or around receptacle 14, a fill status of a particular receptacle 14, a condition of receptacle 14, a location of receptacle 14, and/or other information about the receptacle and waste engaged by, loaded into, or otherwise processed by service vehicle 12. The information may be input in any number of ways, for example via a cab-mounted touch screen interface, via one or more buttons, via a keyboard, via speech recognition, via a mobile device (e.g., a smartphone or tablet) carried by the operator, or in another manner known in the art. In some embodiments, the operator may also be able to respond to inquiries received via input device 40, if desired. In addition to receiving manual input from an operator, input device 40 may also be capable of displaying information, for example the electronic map of environment 10, instructions from back office 34, scheduling, receptacle information (e.g., ID, configuration, location, weight, etc.), payload information (e.g., weight and/or volume), questions, waste audit information, etc.

In some embodiments, input device 40 may be configured to execute an application. For example, when input device 40 is a mobile device (for example an integral component of a smartphone), the application can be a mobile app (“app”). The app can provide a graphical user interface (GUI) that displays information about a waste handling operation to an operator of service vehicle 12, and that receives input from the operator used to configure acquisition of air quality data by sensor 42, to transmit the air quality data to controllers 30, 32 via communication device 44, to receive and display information about a current operation, etc.

Any number of air quality sensors 42 may be mounted at any location suitable for capturing air quality data associated with waste falling from receptacle 14 into bed 16 while lifting device 22 is in its upper-most and tilted position. In one example, air quality sensor(s) 42 are mounted onboard vehicle 12 and positioned around a perimeter of an access opening in bed 16 (e.g., at a leading end, a trailing end, a side, etc.—see FIG. 1) and oriented toward a center of the access opening. In another example, air quality sensor(s) 42 are mounted on receptacle 14 and positioned around a perimeter of an access opening into receptacle 14. In yet another example, air quality sensor(s) 42 are mounted at a customer location, but not on vehicle 12 or receptacle 14. For example, air quality sensor(s) 42 may be mounted to a fence, a wall, a roof, a light pole, or another structure at the receptacle location. It is contemplated that air quality sensor(s) 42 mounted on receptacle 14 or at a customer location may be configured to capture and store air quality readings at times other than when service is being performed. Air quality sensor(s) 42 mounted on receptacle 14 or in other locations at a customer location may be configured to transmit stored readings to controllers 30, 32 via a communication device 44. Controllers 30, 32 may then analyze the air quality data collected prior to service being performed at a receptacle 14.

In another embodiment, air quality sensor(s) 42 may be installed throughout environment 10. Air quality sensor(s) 42 may be configured to intermittently or continuously capture and store air quality readings of the environment 10 at the location where they are installed. These sensor(s) 42 may further be configured to transmit the stored air quality data to controller 30 when a service vehicle 12 is within an appropriate proximity to air quality sensor(s) 42.

It is contemplated that, in addition to capturing air quality data associated with a particular receptacle 14 (e.g., during lifting and/or dumping of receptacle 14) or a particular customer location, air quality sensor(s) 42 could additionally be positioned to capture air quality data during travel of service vehicle 12. For example, one or more air quality sensors(s) 42 may be mounted to service vehicle 12 at a location away from bed 16 (e.g., at a leading end of service vehicle 12, over cab 20), such that these sensor(s) 42 are not significantly affected by waste being dumped into and/or contained within bed 16. These sensor(s) 42 may then be used during travel of service vehicle 12 between service stops, between a service stop and a dump location, and/or during travel at the dump location. As will be explained in more detail below, this information may then be used to determine a geographical quality of air within an environment traversed by service vehicle 12.

In the disclosed embodiment, air quality sensor 42 is modular, self-contained, and only temporarily mounted to service vehicle 12. In this manner, air quality sensor 42 may be used only temporarily with a first service vehicle 12, and then removed and remounted to a second service vehicle 12. In other embodiments, however, air quality sensor 42 is permanently connected to service vehicle 12, receptacle 14, or at a customer location or otherwise in environment 10.

Each air quality sensor 42 may be configured to capture digital air quality data that can be viewed in real or near-real time and/or downloaded for later viewing. For example, air quality sensor 42 may be an infrared radiation sensor, an electrochemical sensor, an electroacoustic sensor, or another type of sensor commonly used to generate signals indicative of an amount of carbon dioxide, methane, ammonia, sulfides, and/or other potentially harmful pollutants in the air. These sensors may measure an attenuation of light, sound, or another variable within a given environment caused by the pollution, and generate a corresponding digital output that is indicative of a concentration of a particular chemical constituent. The digital output may then be stored as data within an internal memory of sensor 42, communicated to onboard controller 30 (e.g., via Bluetooth), and/or communicated to offboard controller 32 via wired or wireless technology. In some instances, the digitized data may be streamed via Bluetooth to controller 30, which may then store the data for later download and/or relay the data to offboard controller 32 via communication device 44. As will be explained in more detail below, corresponding air quality information may be shown on a display 46 at back office 34 and viewed by a human operator.

Onboard controller 30 may be configured to manage communications between other onboard components and offboard controller 32 located at back office 34. For example, onboard controller 30 may receive signals from locating device 38, input device(s) 40, and air quality sensor(s) 42, and correlate the signals, filter the signals, buffer the signals, record the signals, or otherwise condition the signals before directing the signals offboard via communication device 44.

Communication device 44 may be configured to facilitate communication between onboard controller 30 and offboard controller 32. Communication device 44 may include hardware and/or software that enable the sending and/or receiving of data messages through a communications link. The communications link may include satellite, cellular, infrared, radio, and any other type of wireless communications. Alternatively, the communications link may include electrical, optical, acoustical, or any other type of wired communications, if desired. In one embodiment, onboard controller 30 may be omitted, and offboard controller 32 may communicate directly with locating device 38, input device(s) 40, and/or air quality sensor(s) 42, via communication device 44, if desired. Other means of communication may also be possible.

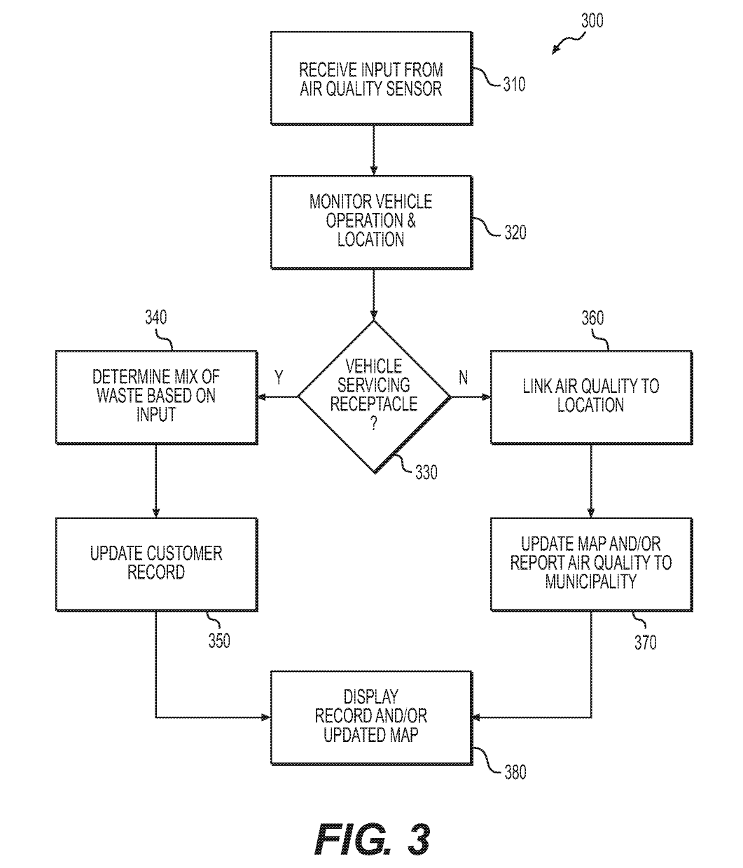

Onboard and/or offboard controllers 30, 32, based on the information received from onboard service vehicles 12 and also based on information received from other sources (e.g., from the Internet, from input at back office 34, from the operator of service vehicle 12, etc.), can be configured to execute instructions stored on computer readable medium to perform methods of waste management at environment 10. For example, onboard and/or offboard controllers 30, 32 may be configured to determine a mix of different types of materials (e.g., recyclables such as cardboard, plastic, glass, metal; biodegradables; hazardous materials; etc.) within the waste collected by service vehicle 12 while at known service stops, and also to determine a general air quality of the environment during travel between service stops. Determination of the waste mix may include, for example, determination of an amount, a volume, a weight, a ratio, a value, a quality, a source, a destination, or another measure of one or more of the different types of materials included in the collected waste. In addition, onboard and/or offboard controllers 30, 32 may be configured to provide recommendations and/or alerts based on the mix, such as how to reduce the waste, how to reduce a cost of the waste service, where to transport the waste, the presence of hazardous waste materials, applicable governmental or company regulations or policies, etc. An exemplary waste management process 300 is illustrated in FIG. 3, and will be explained in more detail in the following section to further illustrate the disclosed concepts.

### INDUSTRIAL APPLICABILITY

The disclosed system may be applicable to the waste service industry, where knowledge of air quality can affect efficiency, profitability, safety, and environmental health. The disclosed system may be able to determine a quality of air within a moving environment around service vehicle 12. The disclosed system may also be able to relate the air quality to an amount, type, quality, and/or mix of waste collected by and/or in a vicinity of service vehicle 12. Air quality data and the related waste information may then be displayed (e.g., onboard service vehicle 12 and/or offboard at back office 34) for use in managing solid waste. In some embodiments, the disclosed system may also be able to alert a customer regarding the waste information and/or to provide recommendations based on the waste information, such that waste-handling processes may be adjusted to reduce waste service costs and/or to improve general air quality. Operation of system 36 will now be described with reference to FIG. 3.

As shown in FIG. 3, method 300 may begin with the monitoring of air quality around service vehicle 12 (Step 310) and the location of service vehicle 12 (Step 320). In particular, as service vehicle 12 moves about environment 10 (referring to FIG. 1), the air quality may be monitored via sensor(s) 42 (referring to FIG. 2) and the location of service vehicle 12 may be monitored via locating device 38. Input indicative of the air quality and the location may be provided by sensor(s) 42 and locating device 38, respectively, to onboard controller 30 (and/or to offboard controller 32, via communication device 44) for further processing. It should be noted that Steps 310 and 320 may be completed in any order, at the same time, and/or continuously during service vehicle operation.

Controller 30 may determine if service vehicle 12 is currently servicing a receptacle 14 (Step 330). This determination may be made based, at least in part, on the tracked location of service vehicle 12. For example, when a current location of service vehicle 12 (as provided by locating device 38) corresponds (e.g., within a threshold distance) with a known service stop or location of a particular receptacle 14, controller 30 may consider servicing of the particular receptacle 14 to be underway. In some embodiments, additional information (e.g., lift arm movement, vehicle travel speed, operator input, receptacle identification, etc.) available from onboard service vehicle 12 may be used in conjunction with the location information to make this determination, if desired.

The air quality data generated by sensor(s) 42 at Step 310 may be used in different ways, depending on when and/or where the data is generated. For example, when controller 32 determines at Step 330 that service vehicle 12 is currently servicing receptacle 14, controller 32 may use the air quality data to determine information associated with (e.g., an amount, type, mix, and/or quality of) any waste being collected from the corresponding receptacle 14 (Step 340). That is, the air quality detected by sensor(s) 42 during receptacle servicing may be primarily due to the amount, type, mix, and/or quality of waste present in receptacle 14. Accordingly, controller 30 may be configured to automatically determine the waste-related information based on machine learning and in association with recognition patterns contained within one or more algorithms, equations, graphs, maps, and/or tables stored in memory. For example, controller 30 may be taught to recognize patterns of chemical constituents detected together, amounts of particular constituents detected at the same time, detection frequencies of constituents, and/or orders of constituents detected by sensor(s) 42 during the dumping of waste material into bed 16 of service vehicle 12, and to correlate the patterns to the amount, type, mix, and/or quality of the waste in the immediate vicinity of sensor(s) 42 (i.e., with the waste collected from receptacle 14 at the current service stop). Corresponding customer records (i.e., records of the customer responsible for the receptacle 14 from which the corresponding waste is being collected) may then be updated by controller 30 with the waste-related information determined at Step 340 (Step 350).

However, when controller 30 determines at Step 330 that service vehicle 12 is not currently servicing a receptacle 14, the air quality data generated by sensor(s) 42 at Step 310 may simply be linked to a current location of service vehicle 12 (Step 360). That is, because no receptacles 14 are being serviced at the time that the air quality data is being generated, solid waste may not necessarily be affecting the air quality. Alternatively, controller 30 may be configured to make a determination based on data collected at the time of service, which may then be used to normalize or tare subsequent sensor readings. Accordingly, the air quality could instead be related to other factors of the environment (e.g., a nearby park, a nearby factory, a body of water, etc.), and controller 30 may simply use the air quality data together with the location information to update a map of the environment stored in memory (Step 370). In addition, in some embodiments, the location-linked air quality data may be provided to a local municipality, company, or other institution (e.g., via communication device 44), allowing the local municipality to analyze and/or address any associated air quality issues.

In a further embodiment, it is contemplated that controller 32 may be used to coordinate or route one or more service vehicle(s) 12 to strategically map the air quality in certain locations and within a desired schedule. For example, a dispatch operator at back office 34 could route one or more service vehicles 12 equipped with air quality sensors 42 to travel along desired and/or optimal routes. The controller 30 and air quality sensor(s) 42 of service vehicle(s) 12 may then collect and store air quality data while traveling along the specified route. By way of a further example, controller 32 may be configured to automatically route service vehicle(s) 12 to collect desired air quality information. Additionally, in the event that a municipality receives an alert indicating the possibility of a potentially hazardous situation (e.g. a gas leak, sewage leak, material spill, etc.), controller 32 may be used to route one or more service vehicle(s) 12 equipped with air quality sensor(s) 42 to gather air quality data in a reported or suspected vicinity to further determine the existence of the hazard based on air quality readings. Because service vehicle(s) 12 regularly perform waste services throughout environment 10, service vehicle(s) 12 may be routed to the location of a reported or suspected hazard, providing air quality data that may assist a municipality to evaluate and determine an appropriate response.

After completion of Steps 350 and/or 370, controller 30 may cause related information to be displayed (Step 380). For example, the air quality data, the location information, the customer record, and/or the updated map of the environment may be shown onboard vehicle 12 (e.g., via device 40) and/or offboard vehicle 12 (e.g., via display 46 at back office 34). The information may be communicated to offboard controller 32 in any number of different ways. For example, the information could be streamed in real or near-real time from onboard controller 30 to offboard controller 32 via communication device 44. Alternatively, onboard controller 30 may record the information into memory for later download to offboard controller 32.

In some embodiments, the customer whose records have been updated at Step 350 may be alerted and/or provided with recommendations regarding the handling of solid waste. The alert may be in the form of a paper and/or electronic communication, and include text and graphics that illustrate a ratio, a volume, and/or a weight of each category of waste material recognized in the mix. The recommendation may include ways in which the customer may reduce waste flow (e.g., by removing cardboard that makes up a substantial portion of the waste, collecting biodegradables separately, etc.) and/or offset waste service costs (e.g., by recycling, by amassing particular materials before disposal or recycling, etc.). The alert and/or recommendation may be generated automatically by onboard controller 30 (and/or offboard controller 32) for a particular customer (e.g., by linking signals from locating device 38 with the air quality data and the corresponding mix determinations) and/or manually.

In some embodiments, the operation of service vehicle 12 may be selectively adjusted based on the mix of waste determined at Step 350 and/or the map updated at Step 370. In particular, a schedule of service vehicle 12 may be adjusted in real-time based on the determined mix of waste just deposited into bed 16. For example, if it is determined that a large enough amount of the collected waste is recyclable or compostable, instead of dispatching service vehicle 12 to a landfill, it may make more sense financially to dispatch service vehicle 12 to a sorting and/or recycling center. This live scheduling adjustment may increase a profitability of the customer and/or the service provider, while simultaneously reducing a footprint on the environment. Similarly, based on the air quality of particular areas traversed by service vehicle 12, a route of service vehicle 12 may be selectively adjusted to reduce pollution contributions to and/or to avoid highly-polluted areas of the map.

It will be apparent to those skilled in the art that various modifications and variations can be made to the disclosed system. Other embodiments will be apparent to those skilled in the art from consideration of the specification and practice of the disclosed system. For example, although system 36 (including sensor(s) 42) have been described as being used in conjunction with a land-based vehicle, it is complicated that system 36 could additionally or alternatively be used with an air-based vehicle (e.g., a drone), a water-based vehicle, or another type of vehicle, if desired. It is intended that the specification and examples be considered as exemplary only, with a true scope being indicated by the following claims and their equivalents.

What is claimed is:

1. A waste management system for use with a service vehicle, comprising:
a sensor configured to generate an air quality signal indicative of a quality of air in a vicinity of the service vehicle;
a locating device configured to generate a location signal indicative of a location of the service vehicle;
a display; and
a controller in communication with the air quality sensor, the locating device, and the display, the controller being configured to:
make a determination that the service vehicle is currently servicing a receptacle;
selectively use the air quality signal to determine a mix of waste in the receptacle based on the determination; and
based on the location signal, cause a representation of the mix of the waste to be shown together with the location of the service vehicle on the display.

2. The waste management system of claim 1, wherein the controller is configured to make the determination that the service vehicle is currently servicing the receptacle based on the location signal.

3. The waste management system of claim 1, wherein the controller is configured to use the air quality signal to determine the mix of waste in the receptacle only when the service vehicle is currently servicing the receptacle.

4. The waste management system of claim 3, wherein the controller is further configured to selectively update an electronic customer record corresponding to the receptacle based on the mix of waste in the receptacle.

5. The waste management system of claim 4, wherein the controller is further configured to make a customer recommendation regarding waste handling based on the mix of waste in the receptacle.

6. The waste management system of claim 3, wherein the controller is further configured to selectively link the air quality signal to the location signal when the service vehicle is not currently servicing the receptacle.

7. The waste management system of claim 6, wherein the controller is further configured to update an electronic map of the environment based on the linked air quality and location signals.

8. The waste management system of claim 7, further including communication device, wherein the controller is further configured to cause at least one of the electronic map, the air quality signal, and the mix of waste to be communicated offboard the service vehicle via the communication device.

9. The waste management system of claim 1, further including an input device configured to receive manual input from an operator of the service vehicle, wherein the controller is further configured to make the determination that the service vehicle is currently servicing the receptacle based on the manual input.

10. The waste management system of claim 1, wherein the sensor, the locating device, and the controller together form a handheld mobile unit.

11. A method for managing waste retrieval by a service vehicle, the method comprising:
sensing an air quality in a vicinity of the service vehicle;
determining a location of the service vehicle;
making a determination that the service vehicle is currently servicing a receptacle;
selectively using the air quality to determine a mix of waste in the receptacle based on the determination; and
based on the location of the service vehicle, displaying a representation of the mix of the waste together with the location of the service vehicle.

12. The method of claim 11, wherein making the determination that the service vehicle is currently servicing the receptacle includes making the determination based on the location of the service vehicle.

13. The method of claim 11, wherein selectively using the air quality to determine the mix of waste in the receptacle includes using the air quality to determine the mix of waste only when the service vehicle is currently servicing the receptacle.

14. The method of claim 13, further including selectively updating an electronic customer record corresponding to the receptacle based on the mix of waste in the receptacle.

15. The method of claim 14, further including making a customer recommendation regarding waste handling based on the mix of waste in the receptacle.

16. The method of claim 13, further including selectively linking the air quality to the location of the service vehicle when the service vehicle is not currently servicing the receptacle.

17. The method of claim 16, further including updating an electronic map of the environment based on the linked air quality and location of the service vehicle.

18. The method of claim 17, communicating at least one of the electronic map, the air quality, and the mix of waste offboard the service vehicle.

19. The method of claim 11, further including receiving manual input from an operator of the service vehicle, wherein making the determination that the service vehicle is currently servicing the receptacle includes making the determination that the service vehicle is currently servicing the receptacle based on the manual input.

20. A non-transitory computer readable medium containing computer-executable programming instructions for a method of managing waste retrieval by a service vehicle, the method comprising:
sensing an air quality in a vicinity of the service vehicle;
determining a location of the service vehicle;
determining that the service vehicle is currently servicing a receptacle based on the location of the service vehicle;
using the air quality to determine a mix of waste in the receptacle only when the service vehicle is currently servicing the receptacle;
linking the air quality to the location of the service vehicle in an electronic map of the environment when the service vehicle is not currently servicing the receptacle; and
selectively displaying at least one of the mix of the waste together with the location of the service vehicle or the electronic map.
